(19) United States
(12) Patent Application Publication
(10) Pub. No.: US 2004/0181013 A1
(43) Pub. Date: Sep. 16, 2004

(54) Impact resistant epoxide resin compositions

(75) Inventor: Hubert Schenkel, Sandhausen (DE)

Correspondence Address: WOODCOCK WASHBURN LLP, ONE LIBERTY PLACE, 46TH FLOOR, PHILADELPHIA, PA, 19103, US

(73) Assignee: Henkel Teroson GmbH

(21) Appl. No.: 10/806,542

(22) Filed: Mar. 23, 2004

Related U.S. Application Data
(63) Continuation of application No. 09/806,961, filed on Jul. 30, 2001.
Application No. 09/806,961 is a 371 of international application No. PCT/EP99/07143, filed on Sep. 25, 1999.

(30) Foreign Application Priority Data
Oct. 6, 1998 (DE) 198 45 607.7

(51) Int. Cl. C08G 65/32

(52) U.S. Cl. 525/406

(57) ABSTRACT

The present invention relates to phenol terminated or aminophenyl terminated products and compositions containing the same. The phenol-terminated or amino-terminated products are produced by reacting a stoichiometric excess of a carboxylic anhydride or dianhydride with a diamine or polyamine, and reacting the excess carboxylic anhydride groups or carboxylic acid groups with at least one polyphenol or aminophenol to form the phenol-terminated or aminophenyl-terminated products. The compounds are preferably utilized in adhesive compositions.

### CROSS-REFERENCE TO RELATED APPLICATION

This is a continuation of U.S. patent application Ser. No. 09/806,961, filed Jul. 30, 2001, which is the U.S National Stage entry of International Application PCT/EP99/07143, filed Sep. 25, 1999, said PCT application in turn claiming priority to DE 198 45 607.7, filed Oct. 6, 1998. The disclosure of each of the foregoing is hereby incorporated herein by reference in its entirety.

### FIELD OF THE INVENTION

This invention relates to mixtures of special copolymers having at least one glass transition temperature of −30° C. or lower and phenol-terminated polyamides or polyimides, mixtures of these components with epoxy resins and/or adducts of epoxy resins with the copolymer having a low glass transition temperature and/or the polyamide or the polyimide and heat-activatable latent hardeners for the resin components and optionally accelerators, fillers, thixotropicizing agents and other typical additives. The invention also relates to a process for the production of these compositions and to their use as a reactive adhesive.

### BACKGROUND OF THE INVENTION

Reactive epoxy-based hotmelt adhesives are known. In machine and vehicle construction and especially in the construction of aircraft, railway vehicles and motor vehicles, components of various metals and/or composite materials are increasingly being joined together with the aid of adhesives. Epoxy adhesives are widely used for high-strength structural bonding, more particularly as heat-curing one-component adhesives which, in many cases, are also formulated as reactive hotmelts. Reactive hotmelts are adhesives which are solid at room temperature and which soften and behave like a thermoplastic material at temperatures of up to about 80 to 90° C. It is only at relatively high temperatures of about 100° C. and higher that the latent hardeners present in these hotmelt adhesives are thermally activated so that irreversible curing to a thermoset occurs. To join the components together, for example in the vehicle industry, the adhesive is first applied warm to at least one substrate surface, after which the parts to be joined are then fitted together. The adhesive then solidifies on cooling and, through this physical solidification, establishes adequate handling resistance, i.e. a temporary bond. The parts thus joined together are further treated in various washing, phosphating and dip painting baths. It is only after this that the adhesive is cured at relatively high temperatures in an oven.

Conventional adhesives and hotmelt adhesives based on epoxy resins are hard and brittle in the cured state. Although the bonds obtained with them are generally characterized by very high tensile shear strength, the adhesives flake off under peel, impact or impact/peel stress, particularly at relatively low temperatures, so that loss of bond strength readily occurs when the adhesive joint is subjected to that kind of stress. Accordingly, numerous proposals have already been put forward with a view to so modifying epoxy resins by flexible additives that their brittleness is clearly reduced. One known process is based on the use of special rubber/epoxy resin adducts which are incorporated as heterodisperse phase in the epoxy resin matrix so that the epoxies become more impact-resistant. These epoxy resin compositions are also referred to as “toughened”. Another known modification of epoxy resins of the above-mentioned type consists in the reaction of a carboxyl-terminated polybutadiene-co-acrylonitrile copolymer with an epoxy resin. This rubber/epoxy adduct is then dispersed in one or more different epoxy resins. The reaction of the epoxy resin with the carboxyl-containing butadiene/acrylonitrile rubber has to be conducted in such a way that the adduct is not prematurely cured. Although correspondingly modified epoxy resin compositions already represent a clear improvement over unmodified epoxy resins in relation to their impact strength, their behavior under peel or impact/peel stress is still not satisfactory.

EP-A-0 343 676 describes hotmelt adhesive compositions made up of a mixture of several epoxy resins, a phenolic resin and a polyurethane/epoxy adduct. The polyurethane/epoxy adduct present therein consists of a reaction product of several polyalkylene glycol homopolymers and copolymers containing primary and secondary OH groups, a diisocyanate and at least one epoxy resin. According to the document in question, these hotmelt adhesive compositions show improved shear resistance, peel strength and impact strength in relation to various commercial one-component hotmelt adhesive compositions. Unfortunately, there is no reference to the adhesive properties of the cured adhesive joint at low temperatures.

U.S. Pat. No. 5,290,857 describes an epoxy resin adhesive composition containing an epoxy resin and a powder-form core/shell polymer and a heat-activatable hardener for the epoxy resin. The powder-form core/shell polymer is composed of a core containing an acrylate or methacrylate copolymer with a glass transition temperature of −30° C. or lower and a shell containing an acrylate or methacrylate copolymer which contains crosslinking monomer units and which has a glass transition temperature of 70° C. or higher, the ratio by weight of the core to the shell being between 10:1 and 1:4. These compositions are said to have excellent adhesive properties, such as peel strength, tensile shear strength and T-peel strength, and also good partial gellability. No mention is made of the properties of bonds with these adhesives at low temperatures.

Similarly, U.S. Pat. No. 5,686,509 describes an adhesion-strengthening composition for epoxy resins consisting of powder-form copolymer particles ionically crosslinked with a mono- or divalent metal cation. The core of the core/shell polymer is composed of a diene monomer and optionally crosslinking monomer units and has a glass transition temperature of −30° C. or lower. The shell copolymer has a glass transition temperature of at least 70° C. and is made up of acrylate or methacrylate monomer units and radically polymerizable unsaturated carboxylic acid units. The adhesive composition is said to contain 15 to 60 parts by weight of the adhesion-strengthening copolymer powder and 3 to 30 parts by weight of a heat-activatable hardening agent to 100 parts of epoxy resin. These compositions are recommended for use as structural adhesives for automobile parts. No mention is made of the low temperature properties of corresponding bonds.

EP-A-0 308 664 describes epoxy resin compositions which contain an epoxide adduct of a carboxyl-containing copolymer based on butadiene/acrylonitrile or similar butadiene copolymers and a reaction product of an elastomeric isocyanate-terminated prepolymer soluble or dispersible in epoxy resins with a polyphenol or aminophenol and subsequent reaction of this adduct with an epoxy resin. In addition, these compositions may contain one or more epoxy resins. Furthermore, aminofunctional hardeners, polyaminoamides, polyphenols, polycarboxylic acids and their anhydrides or catalytic hardeners and optionally accelerators are proposed for hardening these compositions. The compositions in question are said to be suitable as adhesives which can have high strength, a high glass transition temperature, high peel strength, high impact strength or high tear propagation resistance according to their particular composition.

Similarly, EP-A-0 353 190 describes epoxy resin compositions containing an adduct of an epoxy resin and a carboxylated butadiene/acrylonitrile copolymer and a reaction product of a hydroxyl-, mercapto- or amino-terminated polyalkylene glycol with a phenol carboxylic acid with subsequent reaction of the phenolic group with an epoxy resin. According to EP-A-0 353 190, these compositions are suitable for the production of adhesives, adhesive films, patches, sealing compounds, paints or matrix resins.

According to the teaching of EP-A-0 354 498 or EP-A-0 591 307, reactive hotmelt adhesive compositions can be produced from a resin component, at least one heat-activatable latent hardener for the resin component and optionally accelerators, fillers, thixotropicizing agents and other typical additives, the resin component being obtainable by the reaction of an epoxy resin solid at room temperature and an epoxy resin liquid at room temperature with one or more linear or branched amino-terminated polyoxypropylenes. The epoxy resins are said to be used in such a quantity, based on the amino-terminated polyoxypropylene, that an excess of epoxy groups, based on the amino groups, is guaranteed. These adhesive compositions have a high peel resistance in the T-peel test which they retain even at low temperatures.

The problem addressed by the present invention was further to improve reactive adhesives of the type mentioned at the beginning to the extent that they would have adequate flexibility and increased peel strength not only at room temperature but also—and in particular—at low temperatures below 0° C. In particular, they would show high peel strength at low temperatures and under sudden stress so that, even in the event of a crash, structurally bonded parts would meet modern safety standards in vehicle construction. These improvements would be obtained without any deterioration in peel strength at high temperatures or in tensile shear strength. In addition, the reactive adhesives would have to exhibit adequate wash-out resistance immediately after application and before final curing. To that end, the adhesive compositions would have to lend themselves as hotmelts to formulation as a highly viscous adhesive suitable for warm application. Another possibility would be to formulate the compositions as an adhesive that could be gelled by a thermal preliminary reaction in a so-called “white body oven” or by induction heating of the joined parts.

### SUMMARY OF THE INVENTION

The solution provided by the invention to the problem as stated above is defined in the claims and consists essentially in the provision of compositions which contain

A) a copolymer having at least one glass transition temperature of −30° C. or lower and epoxy-reactive groups,

B) a reaction product of a di- or polyamine with a carboxylic anhydride and a polyphenol or aminophenol and

C) at least one epoxy resin.

Components A), B) and C) may also be mixtures of compounds of the type mentioned. Components A) and B) are preferably reacted with a large stoichiometric excess of epoxy resins in separate reactions and then optionally mixed with other epoxy resins, heat-activatable hardeners and/or other additives.

Examples of the copolymers of component A) are 1,3-diene polymers containing carboxyl groups and other polar ethylenically unsaturated comonomers. The diene may be butadiene, isoprene or chloroprene and is preferably butadiene. Examples of polar ethylenically unsaturated comonomers are acrylic acid, methacrylic acid, lower alkyl esters of acrylic or methacrylic acid, for example methyl or ethyl esters thereof, amides of acrylic or methacrylic acid, fumaric acid, itaconic acid, maleic acid or lower alkyl esters or semiesters thereof or maleic acid or itaconic anhydride, vinyl esters, such as for example vinyl acetate or—more particularly—acrylonitrile or methacrylonitrile. Most particularly preferred copolymers A) are carboxyl-terminated butadiene/acrylonitrile copolymers (CTBN) which are commercially available in liquid form under the name of Hycar from B. F. Goodrich. These copolymers have molecular weights of 2,000 to 5,000 and acrylonitrile contents of 10% to 30%. Actual examples are Hycar CTBN 1300 X 8, 1300 X 13 or 1300 X 15.

The core/shell polymers known from U.S. Pat. No. 5,290,857 and from U.S. Pat. No. 5,686,509 may also be used as component A). The core monomers should have a glass transition temperature of or below −30° C. and may be selected from the group of diene monomers as mentioned above or suitable acrylate or methacrylate monomers. The core polymer may optionally contain crosslinking monomer units in small quantities. The shell is made up of copolymers which have a glass transition temperature of at least 60° C. The shell is preferably made up of lower alkyl acrylate or methacrylate monomer units (methyl or ethyl esters) and polar monomers, such as (meth)acrylonitrile, (meth)acrylamide, styrene or radical-polymerizable unsaturated carboxylic acids or carboxylic anhydrides.

However, the adducts of epoxy resins and the liquid CTBN rubbers mentioned above are particularly preferred for component A).

Component B) may be represented by the following formula I:

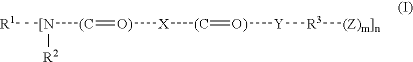

in which

m=1 or 2,

n=2 or 3,

R¹ is an amino-terminated residue of a polyalkylene glycol after removal of the functional groups,

R²═H, C₁₋₆ alkyl, aryl or —(C═O)—; wherein when R²═—(C═O)—, the two carbonyl groups, the nitrogen and X form a five-membered cyclic imide ring,

X═C₂₋₆ alkyl or the residue of an aromatic carboxylic anhydride or dianhydride after removal of the cyclic anhydride group(s),

Y═O—, —S— or —NR⁴—, where R⁴═H or C₁₋₄ alkyl or phenyl,

R³ is a carbocyclic-aromatic or araliphatic m+1-functional residue with groups Z directly attached to the aromatic ring and Z=—OH or —NHR⁴.

Component B) is a reaction product of a di- or polyamine and a carboxylic anhydride, the stoichiometric ratio being selected so that the carboxylic anhydride is preferably in a two-fold excess over the amino groups, after which the remaining carboxylic anhydride groups or carboxylic acid groups are reacted with a polyphenol or aminophenol in a stoichiometric excess so that the condensation product bears terminal phenolic or amino groups. This condensation product is generally mixed directly into the compositions according to the invention although it may also be reacted with a large stoichiometric excess of epoxy resins so that an epoxy-terminated condensation product is formed.

In principle, a large number of diamines or polyamines may be used for the condensation although amino-terminated polyalkylene glycols, more particularly di- or trifunctional amino-terminated polypropylene glycols, polyethylene glycols or copolymers of propylene glycol and ethylene glycol, are preferably used. These glycols are also known under the name of “Jeffamine” (Huntsman). The amino-terminated polyoxytetramethylene glycols, also known as Poly-THF, are also particularly suitable. Other suitable synthesis components are amino-terminated polybutadienes. The amino-terminated polyalkylene glycols have molecular weights of 400 to 5,000.

Examples of suitable carboxylic anhydrides are maleic, succinic, glutaric, adipic, pimelic, suberic, azelaic or sebacic anhydride or, more particularly, anhydrides or dianhydrides of aromatic carboxylic acids or hydrogenation products thereof, such as phthalic anhydride, benzenetricarboxylic anhydride, tetrahydrophthalic dianhydride, mellophanic dianhydride, pyromellitic dianhydride, 1,8:4,5- and 2,3:6,7-naphthalenetetracarboxylic dianhydride, perylene dianhydride, biphenyl tetracarboxylic acid dianhydride, diphenylether tetracarboxylic dianhydride, diphenylmethane tetracarboxylic dianhydride, 2,2-diphenylpropane tetracarboxylic dianhydride or benzophenone tetracarboxylic dianhydride and mixtures thereof.

Besides the carboxylic anhydrides mentioned above, maleinized oils and fats may also be used as anhydride components for the preparation of condensation product B). Maleinized oils and fats and low molecular weight polyenes are known to be prepared by ene reaction or by free radical reaction of maleic anhydride with unsaturated compounds.

The polyphenols or aminophenols to be used for condensation product B) are either aromatic di- or trihydroxy compounds derived from a mono- or polynuclear carbocyclic-aromatic radical or the corresponding aminohydroxy compounds. The aromatic rings may either be condensed or attached to one another by binding links or by a covalent bond.

Examples of the compounds mentioned first are hydroquinone, resorcinol, pyrocatechol, isomers of dihydroxynaphthalene (pure isomers or mixture of several isomers), isomers of dihydroxyanthracene and the corresponding aminohydroxy compounds. The polyphenols or aminophenols, which are derived from carbocyclic-aromatic compounds of which the aromatic nuclei are attached by binding links, may be represented by the following general formula II:

Z—AR—B—AR—Z (II)

in which Z is as defined above,

AR is a mononuclear aromatic radical which may optionally be further substituted by alkyl or alkenyl radicals,

B stands for the binding link which may be selected from the group consisting of a covalent bond, —CR⁵R⁶—, —O—, —S—, —SO₂—, —CO—, —COO—, —CONR⁷— and SiR⁸R⁹— where R⁵, R⁶ and R⁷ independently of one another represent hydrogen, —CF₃ or C₁₋₆ alkyl or R⁵ and R⁶ together with the common C atom form a cycloaliphatic radical with 5 to 7 ring C atoms, R⁸ and R⁹ represent C₁₋₆ alkyl. The two groups B and Z in formula II independently of one another may be located in the ortho, meta or para position. Particularly preferred compounds corresponding to formula II are 4,4′-dihydroxydiphenyl or the bisphenols A and/or F.

Suitable epoxy resins for component C) or for forming the epoxy adduct or for mixing components A) and B) are any of a number of polyepoxides which contain at least two 1,2-epoxy groups per molecule. The epoxy equivalent of these polyepoxides may be between 150 and 4,000. Basically, the polyepoxides may be saturated, unsaturated, cyclic or acyclic, aliphatic, alicyclic, aromatic or heterocyclic polyepoxide compounds. Examples of suitable polyepoxides include the polyglycidyl ethers which are obtained by reaction of epichlorohydrin or epibromohydrin with a polyphenol in the presence of alkali. Polyphenols suitable for this purpose are, for example, resorcinol, pyrocatechol, hydroquinone, bisphenol A (bis-(4-hydroxyphenyl)-2,2-propane)), bisphenol F (bis(4-hydroxyphenyl)methane), bis-(4-hydroxyphenyl)1,1-isobutane, 4,4′-dihydroxybenzophenone, bis-(4-hydroxyphenyl)-1,1-ethane, 1,5-hydroxynaphthalene.

Other polyepoxides suitable in principle are the polyglycidyl ethers of polyalcohols or diamines. These polyglycidyl ethers are derived from polyalcohols, such as ethylene glycol, diethylene glycol, triethylene glycol, 1,2-propylene glycol, 1,4-butylene glycol, triethylene glycol, pentane-1,5-diol, hexane-1,6-diol or trimethylol propane.

Other polyepoxides are polyglycidyl esters of polycarboxylic acids, for example reaction products of glycidol or epichlorohydrin with aliphatic or aromatic polycarboxylic acids, such as oxalic acid, succinic acid, glutaric acid, terephthalic acid or dimer fatty acid.

Other epoxides are derived from the epoxidation products of olefinically unsaturated cycloaliphatic compounds or from native oils and fats.

The epoxy resins obtained by reaction of bisphenol A or bisphenol F are most particularly preferred. Mixtures of liquid and solid epoxy resins are generally used, the liquid epoxy resins preferably being based on bisphenol A and having a sufficiently low molecular weight. Epoxy resins liquid at room temperature which generally have an epoxy equivalent weight of 150 to about 220 and more particularly in the range from 182 to 192 are particularly preferred for the adduct formation of components A) and B).

The hardness of the reactive adhesive in the cooled state, i.e. in particular after application to the substrate to be joined, but before curing, depends on the degree of condensation and hence molecular weight of component B) in particular and on the ratio of solid epoxy resin to liquid epoxy resin. The higher the degree of condensation (and hence the molecular weight) of condensation product B) and the greater the proportion of solid epoxy resin in the composition, the harder the cooled semicrystalline adhesive will be.

Suitable heat-activatable or latent hardeners for the epoxy resin binder system of components A), B) and C) are guanidines, substituted guanidines, substituted ureas, melamine resins, guanamine derivatives, cyclic tertiary amines, aromatic amines and/or mixtures thereof. The hardeners may be stoichiometrically included in the curing reaction although they may also be catalytically active. Examples of substituted guanidines are methyl guanidine, dimethyl guanidine, trimethyl guanidine, tetramethyl guanidine, methyl isobiguanidine, dimethyl isobiguanidine, tetramethyl isobiguanidine, hexamethyl isobiguanidine, heptamethyl isobiguanidine and, most particularly, cyanoguanidine (dicyanodiamide). Alkylated benzoguanamine resins, benzoguanamine resins or methoxymethyl ethoxymethyl benzoguanamine are mentioned as representatives of suitable guanamine derivatives. The selection criterion for the one-component heat-curing hotmelt adhesives is of course their low solubility at room temperature in the resin system so that solid finely ground hardeners are preferred, dicyanodiamide being particularly suitable. The composition is thus guaranteed a long shelf life.

Catalytically active substituted ureas may be used in addition to or instead of the hardeners mentioned above. These substituted ureas are, in particular, p-chlorophenyl-N,N-dimethyl urea (Monuron), 3-phenyl-1,1-dimethyl urea (Fenuron) or 3,4-dichlorophenyl-N,N-dimethyl urea (Diuron). In principle, catalytically active tertiary aryl or alkyl amines, for example benzyl dimethyl amine, tris(dimethylamino)phenol, piperidine or piperidine derivatives, may also be used, but often have too high a solubility in the adhesive system so that the one-component system is not guaranteed useful shelf life in their case. In addition, various, preferably solid imidazole derivatives may be used as catalytically active accelerators. 2-Ethyl-2-methyl imidazole, N-butyl imidazole, benzimidazole and N-C₁₋₁₂-alkyl imidazoles or N-arylimidazoles are mentioned as representatives of such accelerators.

In addition, the adhesives according to the invention contain fillers known per se such as, for example, the various ground or precipitated chalks, carbon black, calcium-magnesium carbonates, heavy spar and, in particular, silicate fillers of the aluminium-magnesium-calcium silicate type, for example wollastonite, chlorite.

The adhesive compositions according to the invention may also contain other typical auxiliaries and additives such as, for example, plasticizers, reactive diluents, rheology aids, wetting agents, antiagers, stabilizers and/or pigments.

The adhesives according to the invention may be formulated on the one hand as one-component adhesives which in turn may be formulated both as highly viscous adhesives designed form warm application and as heat-activatable hotmelt adhesives. These adhesives may also be formulated as one-component pregellable adhesives, in which case the compositions contain either fine-particle thermoplastic powders such as, for example, polymethacrylates, polyvinyl butyral or other thermoplastic (co)polymers or the curing system is so adapted that a two-stage curing process occurs, the gelling step effecting only partial curing of the adhesive and final curing in vehicle construction taking place, for example, in one of the paint ovens, preferably the cathodic electrodeposition oven.

The adhesive compositions according to the invention may also be formulated as two-component epoxy adhesives where the two reaction components are only mixed just before application, curing then taking place at room temperature or moderately elevated temperature. The second reaction component may be selected from the reaction components known per se for two-component epoxy adhesives, for example di- or polyamines, amino-terminated polyalkylene glycols (for example Jeffamine, Amino-Poly-THF) or polyaminoamides. Other reactants may be mercaptofunctional prepolymers such as, for example, the liquid Thiokol polymers. Basically, the epoxy compositions according to the invention may also be cured with carboxylic anhydrides as the second reaction component in two-component adhesive formulations.

Besides the applications mentioned at the beginning, the adhesive compositions according to the invention may also be used as potting compounds in the electrical or electronics industries and as die-attach adhesives in electronics for bonding components to circuit boards. Other possible applications for the compositions according to the invention are as matrix materials for composite materials such as, for example, fiber-reinforced composites.

However, a most particularly preferred application for the adhesives according to the invention is structural bonding in vehicle construction.

The quantity ratios between the individual components may vary within relatively wide limits, depending on the requirements the adhesive is expected to satisfy in regard to its application properties, flexibility, impact peel strength or tensile strength. Typical ranges for the key components are:

component A) 5-25% by weight, preferably 1-20% by weight

component B): 5-30% by weight, preferably 5-20% by weight

component C): 10-45% by weight, preferably 15-30% by weight; this component may be composed of one or more liquid and/or solid epoxy resins in which case it may optionally contain low molecular weight epoxides as reactive diluents

fillers: 10-40% by weight

hardener component (for heat-curable one-component systems): 1-10% by weight, preferably 3-8% by weight

accelerator: 0.01-3% by weight, preferably 0.1 to 0.8% by weight

rheology aid (thixotropicizing agent): 0.5-5% by weight.

As mentioned at the beginning, the requirements modern structural adhesives are expected to meet in vehicle construction continue to increase because more and more structural elements—including those with load-bearing functions—are being joined by bonding processes. As already stated in the article by G. Lötting and S. Singh entitled: “Anforderungen an Klebstoffe für Strukturverbindungen im Karosseriebau” Adhesion 1988, No. 9, pages 19 to 26, the adhesives are expected on the one hand to fulfill production aspects of practical relevance, including automatable application in short cycle times, adhesion to oil-covered metal panels, adhesion to various types of metal panels and compatibility with the process conditions on the paint line (resistance to washing and phosphating baths, curability during stoving of the CED primer, resistance to the following painting and drying operations). In addition, modern structural adhesives have to exhibit improving strength and deformation properties, even in the cured state. These include the high corrosion resistance and flexural strength of the structural components and the deformability of the bond under mechanical stress. High deformability of the structural components guarantees a considerable safety advantage in the event of a crash. This crash behavior can best be determined by determining the impact energy for cured bonds; sufficiently high values for impact energy or impact/peel energy are desirable both at high temperatures of up to +90° C. and in particular at low temperatures down to −40° C. High tensile shear strength should also be achieved. Both strengths should be achieved on a large number of substrates, mainly oil-covered metal panels, for example steel bodywork panels, steel plate galvanized by various methods, panels of various aluminum alloys or even magnesium alloys and steel plates coated by coil coating with organic coatings of the “Bonazinc” or “Granocoat” type. As shown in the following Examples, the adhesive compositions according to the invention surprisingly satisfy these requirements to a very high degree.

The following Examples are intended to illustrate the invention. All quantities in connection with the compositions are parts by weight, unless otherwise indicated.

General Procedure for Producing Component A)

A carboxy-terminated poly(butadiene-co-acrylonitrile) (Hycar CTBN1300 X 13) was reacted for 3 hours with stirring under nitrogen at 140° C. with an approximately 10-molar excess of a liquid DGEBA epoxy resin until the reaction was constant.

General Procedure for Preparing Condensation Product B)

In a stirrable and heatable tank reactor, 1 mole of the carboxylic anhydride or dicarboxylic anhydride was reacted under nitrogen for 3 to 4 hours at 120° C. to 160° C. with 0.4 to 0.7 mole of an amino-terminated polyalkylene glycol, the polyamine being introduced into the reactor first and heated initially to 130° C. The adduct thus formed was reacted with about 1.1 to 1.5 moles of a polyphenol until the reaction was constant. The progress of the reaction was followed by gel permeation chromatography (GPC). This phenol-terminated polymer was then mixed with an epoxy resin, preferably a diglycidyl ether of bisphenol A (DGBEA).

General Production of the Adhesive

In a kneader, components A), B) and a liquid epoxy resin and a solid epoxy resin were mixed to homogeneity at room temperature or optionally at 80° C. in the presence of the fillers, hardeners, accelerators and rheology aids and the resulting mixture was poured into the storage containers optionally while still warm.

### EXAMPLES 1 to 6

The condensation products B) listed in Table 1 were prepared from Jeffamine-D-2000 (polyoxypropylenediamine, molecular weight 2000), pyromellitic dianhydride and resorcinol by the general method for preparing the condensation product B).

TABLE 1

Example

| | 1 | 2 | 3 | 4 | 5 | 6 |
|---|---|---|---|---|---|---|
| D-2000 | 219.0 | 229.5 | 222.0 | 235.5 | 237.6 | 200.0 |
| PMSA | 48.0 | 42.0 | 48.0 | 41.4 | 36.9 | 31.3 |
| Resorcinol | 33.0 | 28.5 | 30.0 | 31.2 | 25.5 | 18.7 |

D-2000 = Jeffamine D-2000
PMSA = pyromellitic dianhydride

Component A) was prepared from Hycar CTBN 1300 X 13 and a liquid DGBEA resin by the method described above. The resulting composition contained 40% butyl rubber and had an epoxy equivalent weight of 900 and a viscosity at 80° C. of 200 Pa.s.

### EXAMPLES 7 to 12

Adhesive compositions according to the invention were prepared from components B) of to Examples 1 to 6, component A) and a liquid DGEBA resin (epoxy equivalent weight 189), fillers, dicyanodiamide as hardener and accelerators and hydrophobic silica as thixotropicizing agent. The compositions are set out in Table 2.

TABLE 2
Adhesives according to the invention

| | Example | | | | | |
|---|---|---|---|---|---|---|
| | 7 | 8 | 9 | 10 | 11 | 12 |
| Component B) of Example 1 | 13.5 | | | | | |
| Component B) of Example 2 | | 13.5 | | | | |
| Component B) of Example 3 | | | 13.5 | | | |
| Component B) of Example 4 | | | | 13.5 | | |
| Component B) of Example 5 | | | | | 13.5 | |
| Component B) of Example 6 | | | | | | 13.5 |
| Component A) | 17.0 | 17.0 | 17.0 | 17.0 | 17.0 | 17.0 |
| DGEBA resin, liquid | 28.0 | 28.0 | 28.0 | 28.0 | 28.0 | 28.0 |
| Wollastonite | 33.7 | 33.7 | 33.7 | 33.7 | 33.7 | 33.7 |
| Dicyanodiamide | 4.5 | 4.5 | 4.5 | 4.5 | 4.5 | 4.5 |
| Fenuron | 0.3 | 0.3 | 0.3 | 0.3 | 0.3 | 0.3 |
| Silica, hydrophobic | 3.0 | 3.0 | 3.0 | 3.0 | 3.0 | 3.0 |

Wollastonite filler
Silica: Carbosil TS 720

The adhesive properties of the Examples according to the invention and the adhesive properties of known adhesives are compared in Table 3. The adhesive of Comparison Example 1 was Terokal 5051 of Henkel Teroson which had been made in accordance with the teaching of EP-A-0 354 498. The adhesive of Comparison Example 2 was Betamate 1044/3 made by Gurit Essex. It is assumed that this adhesive had been produced in accordance with the teaching of EP-A-0 308 664

TABLE 3
Adhesive properties

| | Example | | | | | | | |
|---|---|---|---|---|---|---|---|---|
| | 7 | 8 | 9 | 10 | 11 | 12 | Comp. 1 | Comp. 2 |
| Impact −40° C. [J] | 8.7 | 11.7 | 9.4 | 13.1 | 6.7 | 0.7 | 0.5 | 3.3 |
| Impact −20° C. [J] | 12.7 | 14.7 | 13.4 | 16.2 | 10.5 | 1.9 | 0.4 | 2.6 |
| Impact 0° C. [J] | 13.2 | 13.6 | 15.0 | 16.8 | 12.1 | 3.9 | 0.9 | 4.4 |
| Impact RT [J] | 15.5 | 14.7 | 16.1 | 16.0 | 12.9 | 5.0 | 2.1 | 5.2 |
| TSS −40° C. [Mpa] | 34.1 scf | 31.1 scf | 25.2 scf | 30.9 cf | 28.4 cf | 37.8; 80% cf | 19.8 cf | 20.2 cf |
| TSS RT [Mpa] | 25.7 cf | 22.7 cf | 21.6 cf | 22.5 cf | 18.7 cf | 16.4; 80% cf | 21.8 cf | 21.6 cf |
| TSS +90° C. [Mpa] | 14.8 c | 11.9 cf | 11.4 cf | 12.0 cf | 11.0 cf | 12.4 cf | 10.9 cf | 11.1 cf |
| 500 h SST | 20.3 c | 17.0 cf | 17.0 cf | 18.9 cf | 17.0 cf | n.a. | 19.3 cf | 18.8 cf |
| 1000 h SST | 19.1 c | 17.9 cf | 14.5 cf | 18.2 cf | 16.6 cf | n.a. | 17.5 cf | 16.7 cf |

Impact: impact peel test to ISO 11343 at 2 m/sec
RT: room temperature
TSS: tensile shear strength to DIN 53283
TSS: salt spray test to DIN 50021
cf: cohesive fracture pattern 100% unless otherwise indicated
scf: cohesive fracture pattern with partial film residue on a substrate

As these test results show, the impact peel energy to ISO 11343 of the adhesives according to the invention is several times higher than that of the known adhesives. At very low temperatures in particular, the impact peel energy of the adhesives according to the invention is clearly better than that of the known adhesives without any deterioration in tensile shear strength or ageing behavior in the salt spray test.

What is claimed:

1. A compound of formula I: 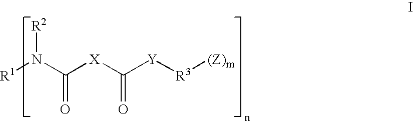
wherein:
R¹ is a residue of polybutadiene or a polyalkylene glycol after removal of the functional groups;
R² is H, C₁₋₆ alkyl, aryl or —(C═O)—; wherein when R² is —(C═O)—, R² and X, together with the nitrogen atom and carbonyl through which they are connected form a five-membered cyclic imide ring;
X is C₂₋₆ alkyl or the residue of an aromatic carboxylic anhydride or dianhydride after removal of the cyclic anhydride group(s);
R³ is -[(aryl-R⁵)ₚ-aryl]-,
Y is —O—, —S— or —NR⁴—;
Z is —OH or —NHR⁴;
R⁴ is H, C₁₋₄ alkyl or phenyl;
R⁵ is a covalent bond, —O—, —S—, —SO₂—, —CO—, —COO—, —C(═O)N(R⁷)—, —C(R⁵)(R⁶)— or —Si(R⁸)(R⁹)— wherein R⁵, R⁶ and R⁷ each independently represent hydrogen, —CF₃ or C₁₋₆ alkyl and R⁸ and R⁹ represent C₁₋₆ alkyl, or R⁵ and R⁶ together with the carbon atom to which they are attached form a 5- to 7-membered carbocyclic ring;
m is 1 or 2;
n is 2 or 3; and
p is 0 or 1.

2. A compound according to claim 1 wherein R¹ is a residue of polyalkylene glycol after removal of the functional groups.
